(19) United States
(12) Patent Application Publication
(10) Pub. No.: US 2004/0243742 A1
(43) Pub. Date: Dec. 2, 2004

(54) Method of transferring data in an electronic circuit, electronic circuit and relating device

(76) Inventors: Andrea Bragagnini, Torino (IT); Pierangelo Garino, Torino (IT); Maura Turolla, Torino (IT); Antonio Varriale, Torino (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/488,481

(22) PCT Filed: Aug. 26, 2002
(86) PCT No.: PCT/IT02/00549

(30) Foreign Application Priority Data
Aug. 30, 2001 (IT) TO2001A000838

(51) Int. Cl. G06F 13/00

(52) U.S. Cl. 710/33

(57) ABSTRACT

The present invention is related to a method of transferring data in an electronic circuit (10) incorporating a control unit or CPU (21), first circuit blocks (41) and second circuit blocks (61) interconnected by means of a BUS (24). The method and the relating circuit envisage the use of interface devices (45a) and/or (45b), associated to respective circuit blocks, and capable of managing the direct transfer of data from the first block (41) to the second block (61), or vice-versa, without the control by the CPU (21) during such a transfer. For the purpose of this method, and relating circuit (101), interface device (45a) must be, able to intercept control commands issued by CPU (21) and to directly manage the data transfer from the first block (41) to the second block (61) .Thus, the method and the circuit (101), and the interface device (45a) make it possible to considerably reduce the load of CPU 21, BUS 24 and electronic circuit (101) as well.

### TECHNICAL FIELD

The present invention concerns a method of transferring data in an electronic circuit, incorporating a control unit (CPU), a first circuit block having storage means and a second circuit block capable of exchanging data with said first circuit block.

The present invention also concerns an electronic circuit and a device, designed to implement the method according to the invention.

In particular, the present invention concerns test subsystems capable for instance of implementing and emulating transmission and reception chains in which circuit blocks implemented in the form of hardware blocks and/or in the form of firmware blocks co-exist, and in which the test procedure consists of selectively activating the functions of the blocks forming the chain and monitoring for instance the data transfer from one block to the other through the RAM.

### BACKGROUND ART

As is well known, the data exchange between hardware and/or firmware circuit blocks, capable of performing specific processing functions, heavily engages the CPU, in particular within the test or emulation subsystems of electronic circuits.

Let us consider by way of example the logic diagram of FIG. 1, relating to an emulation or test subsystem 10, of a known type, for instance, the emulation subsystem model ARM INTEGRATOR/AP by ARM Corp., designed for the behaviour emulation of a circuit formed by a plurality of hardware and/or firmware blocks.

Said subsystem 10 incorporates in one of its possible configurations a basic board 12, a first module 14, in which at least one programmable logic circuit of FPGA (Field Programmable Gate Array) type, 41, can be housed, and a second module 16, in which at least one microprocessor of DSP (Digital Signal Processor) type, 61, can be housed.

Basic board 12 of said subsystem 10 incorporates a control microprocessor (CPU) 21, for instance of the ARM7TDMI type, a random access memory (RAM) 22 and a channel for addresses, controls and data (BUS) 24. To BUS 24 there are connected, in a known way, the CPU 21, the RAM 22, the PFGA 41 and the DSP microprocessor 61.

As generally known, during the emulation phases the data transfer from a hardware block, which is emulated for instance by means of the logic circuit PFGA 41, and a firmware block, emulated for instance by means of the DSP 61, is performed in the following way:

once logic circuit FPGA 41 has carried out the processing functions implemented in the same PFGA 41 and has informed CPU 21 of the completion of said operation, CPU 21 starts checking step by step the transfer to RAM 22 of the data processed by PFGA 41, through

access to BUS 24 to read the processed data from logic circuit FPGA 41;

access to BUS 24 to write the data just read into RAM 22 ; and

upon completion of the transfer to RAM 22, CPU 21 reads the data from RAM 22 and transfers them to DSP 61 through:

access to BUS 24 to read the previously stored data from RAM 22; and

access to BUS 24 to write the data just read into DSP 61.

Obviously, the transfer process from DSP 61 to FPGA 41 is substantially similar, but in the inverse direction.

A first technical problem in the background technique is due to the fact that by each transfer from FPGA (hardware block) 41 or from DSP (firmware block) 61, and vice-versa, BUS 24 is engaged twice and that by each transfer from hardware block 41 to firmware block 61, or vice-versa, BUS 24 is engaged four times, thus causing the overloading of BUS 24, in particular in the cases in which the subsystem 10 is required to emulate for instance a transmission chain in real time.

A second problem of the state of the art lies in the fact that, during any transfer of data, CPU 21 is required to manage and monitor the data transfer step by step, and all this prevents CPU 21 from carrying out additional processing functions required for the emulation of the electronic circuit to be tested.

Owing to the issues of the state of the art set out above, it is often necessary to increase the characteristics of the BUS or CPU of the system being used, so as to support the overloading resulting from the data transfer from block to block or from block to RAM.

Obviously, the problems indicated above may be present not only within the emulation subsystems described herein, but also in general in all the electronic circuits of a medium or high complexity, in which the data transfer between circuit blocks performing specific processing functions does follow methodologies similar to those highlighted here.

### DISCLOSURE OF THE INVENTION

The aim of the present invention is a method of transferring data in an electronic circuit that allows a reduction in the load of CPU and BUS by at least 50% as compared to the present state of the art, without a significant cost increase.

Aim of the present invention is also an electronic circuit and device, capable of reducing the overload of CPU and BUS during the data transfer from a circuit block to the RAM or from a first circuit block to another block.

This aim is attained by the method, the circuit and the device described herein, as set forth in the claims.

In particular the aim is attained by the method according to the invention whereby the CPU functions relating to the data transfer from a circuit block to the RAM or from block to block are intercepted and directly managed by electronic devices associated to the same circuit blocks.

Further, the aim is attained by the electronic circuit according to the invention in which the circuit blocks, either hardware or firmware, are associated to corresponding devices designed to directly manage the transfer from or to the RAM or from block to block without the CPU control.

By virtue of an additional characteristic of the present invention, each electronic device associated to a circuit block, in addition to easing up the load of CPU and BUS, is also designed, being programmable, to provide for instance adaptation functions of the block to the circuit and to make the same circuit block, either hardware or firmware, substantially “neutral”, i.e. independent of the circuit on which the block itself is located.

### BRIEF DESCRIPTION OF DRAWINGS

This and other characteristics of the present invention will be clarified by the following description of a preferred form of embodiment, made by way of a non limiting example, by means of the attached drawings wherein:

FIG. 1 shows a block diagram of an emulation subsystem, according to the state of the art;

FIG. 2 illustrates a block diagram of an emulation subsystem or electronic circuit according to the present invention; and

FIG. 3 depicts a block diagram of the device designed to implement the electronic circuit of FIG. 2.

### BEST MODE FOR CARRYING OUT THE INVENTION

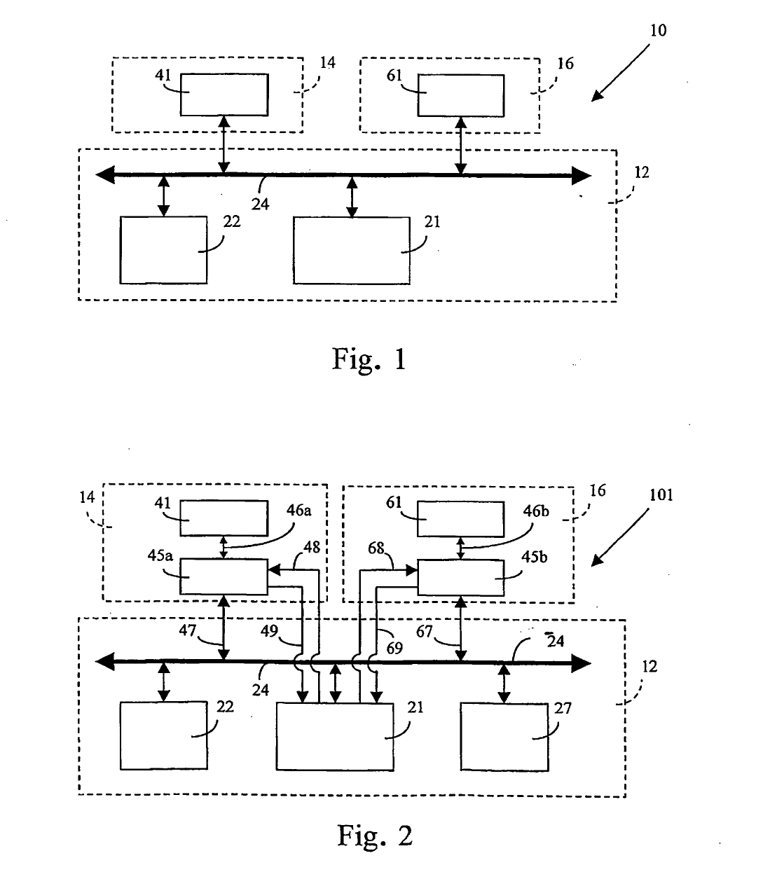

With reference to FIG. 2, an electronic circuit 101 according to the invention is for instance formed by an emulation subsystem of the type described in FIG. 1, wherein to the hardware block 41 and to the firmware block 61 are associated a first interface device (first device) 45a and a second interface device 45b, situated between the respective blocks 41 and 61, and BUS 24, respectively.

In particular, in agreement with the present example of embodiment, the first module 14, formed for instance by the ARM INTEGRATOR/LM module, includes a programmable logic circuit of FPGA type (hardware block) 41, for instance type XC200E by XILINK Corp., and the first device 45a.

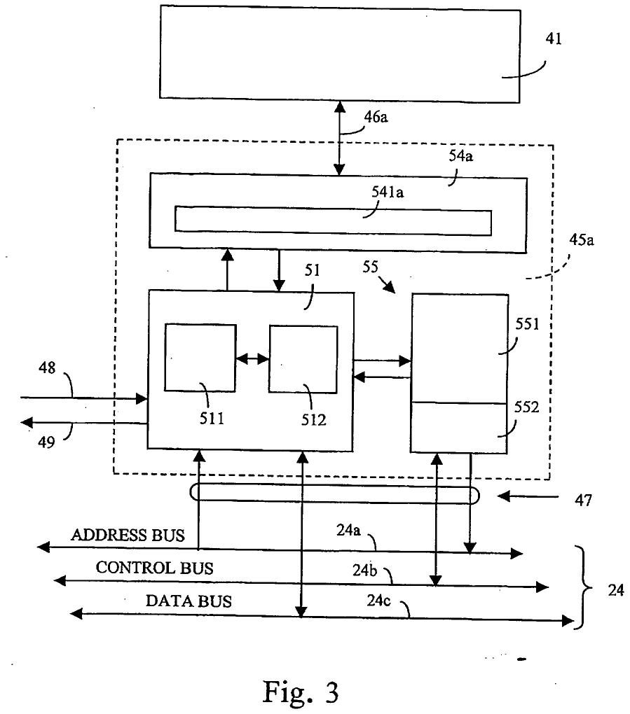

The first device 45a is connected by means of a first connection 46a to the hardware block 41, by means of a second connection 47 to BUS 24 (FIGS. 2 and 3), incorporating as known an ADDRESS BUS 24a, a CONTROL BUS 24b and a DATA BUS 24c, and by means of control wires 48 and 49 of a known type, for instance, for the exchange of Interrupt I/O signals with the CPU 21.

The second module 61, formed for instance by a PCI (Peripheral Component Interconnect) module of a known type, includes a DSP microprocessor (firmware block) 61, for instance TMS320C6201 by Texas Instruments Corp., and the second device 45b.

The second device 45b is connected by means of a first connection 46b to the firmware block 61, by means of a second connection 67 to the BUS 24 and by means of control wires 68 and 69 of a known type, to the CPU 21.

As will be explained in detail in the sequel, circuits 45a e 45b are designed to intercept determined control commands (commands) coming from the CPU 21 and to control the transfer of data from their respective blocks 41 and 61 to RAM 22, and vice-versa, or from the hardware block 41 to the firmware block 61, and vice-versa, without the control by CPU 21. Obviously, as is easily understood by those skilled in the art, the presence on circuit 101 of devices 45a and 45b, also requires the presence of a control circuit (BUS arbiter) 27, of a known type, designed to control the sequential access to BUS 24 by CPU 21 and devices 45a and 45b.

Device 45a e 45b only differ by specialisation features relating to the characteristics of the block to which they are associated. Structure and functions of first device 45a will be therefore described in the sequel.

Concerning the connections, as will be set forth hereinafter, connections 46a and 46b are specific and bound to the characteristics of respective blocks 41 and 61, whilst connections 47, 48 and 49 and their corresponding 67, 68 and 69 are of an equivalent type.

Device 45a comprises, for instance, a component capable of controlling the data transfer (TRANS CONTROLLER) 51, a component for controlling the memory (MEMORY CONTROLLER) 55, and a block interface component (BLOCK CONTROLLER) 54a.

The TRANS CONTROLLER 51 is connected to MEMORY CONTROLLER 55, BLOCK CONTROLLER 54a , ADDRESS BUS 24a and DATA BUS 24c, and is designed to exchange commands with CPU 21, over control wires 48 and 49, and to exchange data for instance with RAM 22 by interacting with MEMORY CONTROLLER 55, or collecting data from DATA BUS 24c, and transferring them to BLOCK CONTROLLER 54a, or vice-versa. The TRANS CONTROLLER 51 is also designed to exchange commands with CPU 21 by means of DATA BUS 24c, in order to carry out, for instance, initialisation functions or special functions defined at the design stage of electronic circuit 101 and/or device 45a, as will be described in detail later.

The TRANS CONTROLLER 51 is formed, for instance, by a state machine of a known type, capable of effecting a sequence of predefined operations in connection with predefined commands, such as Interrupt I/O signals coming from CPU 21 or a particular bit configuration present on DATA BUS 24c during the initialisation stage.

In a preferred form of embodiment, the state machine of TRANS CONTROLLER 51 comprises, for instance, a memory for storing programs (program memory) 511, and a sequencer circuit 512, both of a known type.

The program memory 511 serves, for instance, to store a plurality of instruction sequences, developed at the design stage, or defined at the configuration stage of the electronic circuit 101.

The sequencer circuit 512 is connected to the program memory 511 and is capable selectively reading and carrying out, according to predefined commands coming from CPU 21, the instruction sequences stored on the program memory 511.

Obviously, the different instruction sequences may be implemented at the development or configuration stages of electronic circuit 101, and are diversified, in a preferred form of embodiment, into standard operation functions and initialisation functions.

The MEMORY CONTROLLER 55 is connected to the TRANS CONTROLLER 51, ADDRESS BUS 24a and CONTROL BUS 24b, and has the duty of requesting CONTROL BUS 24b, in a known manner, in connection with commands coming from TRANS CONTROLLER 51, to activate read or write operations from or to an address of RAM 22, or an address of an additional circuit block on ADDRESS BUS 24a, or on registers internal to MEMORY CONTROLLER 55 itself.

For general use purposes, MEMORY CONTROLLER 55 comprises, for instance, a MEMORY CONTROLLER GENERIC 551, capable of generating a generic request function towards CONTROL BUS 24b, and an adaptation unit or MEMORY CONTROLLER SPECIFIC 552, capable of specialising the requests to CONTROL BUS 24b as a function of the type of CONTROL BUS being used on the electronic circuit 101.

The MEMORY CONTROLLER 55 may be implemented for instance by using a discrete logic of a known type, or also, through synthesis, starting from a memory controller belonging to a library of components of said type and it will preferably incorporate some registers to store addresses of RAM 22 to be used for reading or writing data or addresses of additional circuit blocks for a direct transfer of data.

Obviously, said addresses may be defined at the configuration stage of device 45a, as a function of the characteristics of the associated block 41, or predefined at the design stage of the electronic circuit 101.

The BLOCK CONTROLLER 54a is connected to the hardware block 41 and to the TRANS CONTROLLER 51 and is designed to control hardware block 41, on the basis of the commands coming from the TRANS CONTROLLER 51, in order that the specific functions of the hardware block 41 are carried out.

The BLOCK CONTROLLER 54a has also the duty, upon completion of the specific functions by hardware block 41, of informing TRANS CONTROLLER 51 about the completion of said functions by the same block 41.

The BLOCK CONTROLLER 54a preferably comprises an I/O BUFFER 541a, of a known type, for storing, in accordance with the present example of embodiment, data to be exchanged between hardware block 41 and RAM 22, or another block. In particular, I/O BUFFER 541a serves for instance to alternatively store either data at the input of block 41 at the time of activation of the same block, or data at the output of block 41 upon completion of the functions of the same block.

The BLOCK CONTROLLER 54a of the interface device 45a and the BLOCK CONTROLLER of the interface device 45b are specialised on the block to which they are associated, since the activation characteristics of respective blocks (41 and 61) and the size of the data to be exchanged for each block are generally diversified from block to block thus, devices 45a and 45b differ, in accordance with the present example of embodiment, only by the characteristics of respective BLOCK CONTROLLERs, which, as described before, depend in turn on the characteristics of blocks 41 and 61 to which they are interfaced.

The BLOCK CONTROLLERS may be implemented for instance through elementary logic circuits or also through state machines having predefined functions in relation to commands coming from the associated TRANS CONTROLLER or respective block 41 or 61.

Preferably, at the initialisation stage of electronic circuit 101, the BLOCK CONTROLLERS are designed to be programmed by CPU 21 by means of the associated TRANS CONTROLLER. Therefore by virtue of said characteristic they are able to allow the adaptation of the characteristics of respective blocks to those of the electronic circuit on which they are placed.

By virtue of the described architecture and in agreement with the present invention, device 45a associated to hardware block 41 and device 45b associated to firmware block 61 are able to activate and perform the data transfer from RAM 22 to respective blocks (41 and 61), and vice-versa, by greatly reducing the load of CPU 21 and BUS 24.

Let us consider as an example the data transfer from the hardware block 41 to the RAM 22.

In connection with the signalling by BLOCK CONTROLLER 54b of the completion of the functions of hardware block 41, TRANS CONTROLLER 51 sends the request—without requiring CPU 21 to intervene—to MEMORY CONTROLLER 55 to activate the writing on RAM 22 of content of I/O BUFFER 541a to the addresses indicated on the registers inside MEMORY CONTROLLER 55. Following the activation of write commands, the TRANS CONTROLLER 51 transfers the content of I/O BUFFER 541a to the RAM 22, and when said transfer has ended, it sends CPU 21 over wire 49 an Interrupt I/O signal to inform of transfer completion.

As will be easily appreciated by those skilled in the art, thanks to the present invention the data transfer from hardware block 41 to RAM 22 does not require the intervention of CPU 21 and occupies BUS 24 only once; thus allowing, all conditions being equal, a reduction of CPU 21 load and by 50% of BUS 24 occupation, as compared to the state of the art.

For the sake of completeness, the description also includes an example relating to the determination of the addresses of RAM 22 on which the data are to be stored. Said operation may be carried out at a initialisation or start up stage of the electronic circuit 101 by envisaging for instance that over DATA BUS 24c during said stage 51 a predefined command of initialisation is presented to the TRANS CONTROLLER 51 by the CPU 21 and that upon this instruction the TRANS CONTROLLER 51 reads from the ADDRESS BUS 24c the addresses of RAM 22 to be used for read and write operations by the associated block and stores them into the registers internal to the MEMORY CONTROLLER 55.

The operation of electronic circuit 101 described so far is the following.

At the initialisation step, the CPU 21 configures all the devices present on the electronic circuit, for instance devices 45a and 45b, by sending specific commands to each device, 45a or 45b, and presenting on the ADDRESS BUS 24a the addresses of RAM 22 or of the blocks which each device must use at the write and read phases for exchanging data in operation.

During the operation phases, for instance, data reading from RAM 22, the CPU 21 notifies, by means of Interrupt I/O signals, to devices 45a or 45b that the data are available for reading, in order that devices 45a or 45b may collect the data from RAM 22, at the address defined at the initialisation stage, and make them available to the respective blocks 41 and 61, without any additional intervention by CPU 21.

During the writing of data on RAM 22, for instance, the devices 45a or 45b engage BUS 24 and directly transfer the data from respective blocks 41 or 61 to RAM 22 to the addresses assigned at the initialisation stage, and only upon transfer completion they notify, by means of Interrupt I/O signals, the end of the write operation to CPU 21.

Thanks to devices 45a and 45b, write and read operations from and to RAM 22 are performed in such a way that

CPU 21 only carries out the control functions of electronic circuit 101 and does not look, for instance, to the specific function of data transfer in the transmission chain;

BUS 24 is not engaged by CPU 21 during the data transfer operations; as a matter of fact, CPU 21 only acts on the basis of Interrupt I/O signals, and uses BUS 24 only in the event of initialisation commands or in the event of specific control commands, such as, for instance, the emptying of the output buffer of block 41 or 61, without extracting data from RAM 22, etc.

In case of direct data transfer from a first block to a second circuit block, the configuration of electronic circuit 101 is such that devices associated to the blocks contain write and read addresses corresponding to the devices on which the read and write operations must be performed.

In this form of implementation, for instance, at the initialisation stage CPU 21 sends to device 45a the address of the I/O BUFFER of device 45b, for its storing on the internal registers of the MEMORY CONTROLLER 55.

During the operation phases, in connection with Interrupt I/O signals coming from CPU 21, device 45a activates hardware block 41 for carrying out the defined functions, and upon completion of said functions, it directly transfers the processed data to device 45b; only at the end of said transfer, in accordance with such form of embodiment, device 45a informs, through Interrupt O/I signals, CPU 21 of the end of block 41 activity and of the transfer.

As will become evident to those skilled in the art, this form of embodiment reduces the occupation of BUS 24 and CPU 21 by more than 50%, as compared to the existing state of the art.

The description has been effected making reference to a first device 41a, associated to a hardware block 41, and to a second device 41b, associated to a firmware block 61, and the data exchange between said blocks, but it will become evident to those skilled in the art that the characteristics of the invention remain unchanged in the case in which the devices are associated to homogeneous blocks, for instance, all of hardware type or firmware type, and the data exchange takes place between homogeneous blocks.

Devices 45a e 45b have been described as separate from their respective circuit blocks 41 and 61 to which they are associated. As will be clear to those skilled in the art, device 45a may be for instance implemented by synthesis and integrated into hardware block 41, being formed, as already described, by circuit elements the models of which may be easily retrieved from a library of components.

Likewise, device 45b, associated to firmware block 61, may be implemented in the form of a firmware performing the logic architecture of the described device, provided that, as will become evident to those skilled in the art, the imicroprocessor or DSP used as firmware block is capable of being directly connected to BUS 24 and to control wires 68 and 69.

The present description has been made by associating a respective device to each circuit block, but as will be clear to those skilled in the art, said condition is strictly required only to guarantee that each block may directly transfer data to other blocks, without increasing the CPU and BUS load.

Obvious modifications or variations are possible to the above description, concerning size, dimensions, forms, materials, components, circuit elements, connections and contacts, as well as details of the circuitry and implementation presented herein, and of the method of operation, without departing from the spirit and scope of the invention, as defined by the appended claims.

1. Method of transferring data in an electronic circuit (101) comprising a control unit (21), a first circuit block (41) capable of performing first processing functions and a second circuit block (61) capable of performing second processing functions, characterised by the following steps:
intercepting by means of an interface device (45a ) associated to said first block (41) specific commands issued by said control unit (21);
activating said first block (41) for performing said processing functions and generating processed data;
transferring in a direct manner from said first block (41) to said second block (61, 22) the processed data under the control of said interface device (45a).

2. Method according to claim 1, characterised by the additional step of
transmitting by said interface device (45a) to said control unit (21) upon completion of the transfer of said processed data, signals (I/0) indicative of said completion.

3. Electronic circuit comprising
a control unit (21);
a first circuit block (41) capable of performing first processing functions; and
a second circuit block (61) capable of performing second processing functions; characterised by:
an interface device (45a) associated to said first circuit block (41) and capable of:
intercepting specific commands issued by said control unit (21),
activating said first block (41) to generate processed data to be transferred to said second block (61), and
managing in a direct manner the transfer of the processed data from said first block (41) to said second block (61).

4. Electronic circuit according to claim 3, characterised in that said interface device (45a) comprises:
a controller (51) capable of managing said specific commands issued by said control unit (21) by activating instruction sequences defined on the basis of said specific commands.

5. Electronic circuit according to claim 4, characterised in that said controller (51) comprises:
a memory unit (511) capable of storing a plurality of instruction sequences selectively actionable.

6. Electronic circuit according to claim 3, characterised in that said interface device (45a) comprises:
a memory control unit (55) capable of controlling the data transfer from said interface device (45a) to predefined addresses associated to said second circuit block (61).

7. Electronic circuit according to claim 3, characterised in that said interface device (45a) comprises:
a block interface unit (54a) capable of activating said first circuit block (41) to carry out said first processing functions.

8. Electronic circuit according to claim 3, characterised by the fact of being an emulation subsystem for emulating data transmission chains among a plurality of circuit blocks (41, 61).

9. Electronic circuit according to claim 8, characterised in that said circuit blocks comprise circuit blocks of hardware type (41) and/or circuit blocks of firmware type (61).

10. Electronic circuit according to claim 8, characterised in that each of said circuit blocks (41, 61) is associated to a corresponding interface device (45a, 45b).

11. Interface device to be associated to a first circuit block (41) for transferring data through a BUS (24) from said first circuit block (41) to a second circuit block (61) capable of performing processing functions, characterised by:
components (51, 55, 54a) connected to said circuit block (41) and to a control unit (21) and capable of exchanging commands with said control unit (21) and of controlling said circuit block (41) to perform predetermined processing functions, to generate processed data and to transfer the processed data in a direct manner from said first circuit block (41) to said second circuit block (61) by means of said BUS (24).

12. Interface device according to claim 11, characterised in that said components (51, 55, 54a) comprise:
a control component (51) connected to the BUS (24) and to the control unit (21) and capable of intercepting commands of said control unit (21) and of activating instruction sequences defined on the basis of said commands.

13. Interface device according to claim 12, characterised in that said control component (51) comprises:
a memory unit (55) capable of storing a plurality of instruction sequences selectively actionable.

14. Interface device according to claim 11, characterised in that said components (51, 55, 54a) comprise:
a memory control unit (55) connected to said BUS (24) and capable of controlling the transfer of the processed data to predefined addresses.

15. Interface device according to claim 14, characterised in that said memory control unit (55) comprises:
an adaptation unit (552) capable of being adapted to said BUS (24).

16. Interface device according to claim 11, characterised in that said components (51, 55, 54a) comprise:
a block interface component (54a) connected to said circuit block (41) and capable of activating said circuit block (41) to perform said predetermined processing functions.
